(19) United States
(12) Patent Application Publication
(10) Pub. No.: US 2015/0155723 A1
(43) Pub. Date: Jun. 4, 2015

(54) MULTI-FUNCTIONED SMART SWITCHING CHARGER WITH TIME STAGE CONTROL

(71) Applicant: GO-TECH ENERGY CO., LTD., New Taipei City (TW)

(72) Inventor: Pao-Sheng HUANG, MiaoLi County (TW)

(73) Assignee: GO-TECH ENERGY CO., LTD., New Taipei City (TW)

(21) Appl. No.: 14/096,205

(22) Filed: Dec. 4, 2013

(51) Int. Cl. H02J 7/00; H02J 7/02

(52) U.S. Cl. CPC H02J 7/0022; H02J 7/0042; H02J 7/0052; H02J 7/0088; H02J 7/02

(57) ABSTRACT

A multi-functioned smart switching charger with time stage control is disclosed. The switching charger includes: a charging device, several output units, a switch control unit and a charging control unit. The charging device outputs direct current only to one output unit per charging until the rechargeable battery under charging is fully charged. The present invention provides a switching charger which utilizes only a charging device to charge connected rechargeable batteries sequentially. It saves material cost and space used. Meanwhile, charging time can be set up to off-peak hours. Power cost for charging can be saved.

### FIELD OF THE INVENTION

The present invention relates to a multi-functioned smart switching charger. More particularly, the present invention relates to a multi-functioned smart switching charger having time stage control.

### BACKGROUND OF THE INVENTION

Rechargeable batteries are widely used in many products, such as notebooks, tablets, mobile phones, and even large electric vehicles and robots. Although a rechargeable battery is composed of a number of rechargeable battery cells linked in series or parallel, according to different power supply targets, there are different specifications of output current and voltage.

Generally, rechargeable batteries with smaller output current and capacity can be charged by the host connected or by external chargers with transformed power from the mains supply. Because the requirement of current and capacity is not huge and size is small, many chargers are able to charge several rechargeable batteries at the same time. However, with many large moveable equipment, such as electrically vehicles and robots) gradually getting into people's life, the rechargeable batteries they used have larger requirement than the aforementioned ones, no matter power capacity or current. Those large power capacity (or current) rechargeable batteries usually use special chargers to charge, or are charged in a charging station. Regardless these chargers or charging stations cause troubles in occupying too much space, it costs lots to set them up only to charge the limited number of rechargeable batteries. Especially, the chargers or charging stations are not always working. It is a waste if workload is not full.

However, since demand of large rechargeable batteries is strong. Inevitably, the mentioned chargers or charging stations are necessary to be provided continuously. Since many large electrically driven devices, such as electrical vehicles or electrical bicycles, would use rechargeable batteries with similar specification and they might be charged at home or some specified places, for example, parking lots, it is necessary to provide large multi-rechargeable battery chargers so as to solve the problem that there are too many large chargers around our life.

Like the charging principles of small multi-rechargeable battery charger, a large multi-rechargeable battery has similar structures and is as shown in FIG. 1. In FIG. 1, a large multi-rechargeable battery charger 5 includes a power control device 10 and several charging device 11. The power control device 10 is connected to mains supply 20, reduces the alternating current from the mains supply 20 and properly allocates power to each charging device 11 according to requirement of charging capacity. Each of the charging devices 11 will transform the alternating current into direct current when the power from the power control device 10 is received and charge a rechargeable battery (not shown) connected to the charging device 11.

From FIG. 1, it is intuitive to know that each charging device 11 should have identical design. That is to say that it is to duplicate a single charging device to get some clones and assemble them as a part of the large multi-rechargeable battery charger 5. However, for the charging device 11, it can be divided into several parts. The most expensive ones are charging circuits and related devices. Others, for example, output cables and charging plugs are relatively cheap. Therefore, if the mentioned large multi-rechargeable battery charger 5 can not keep charging with its full capacity, the charging device 11 which is not working will cause waste of resources. Under such situation, if the number of the charging circuits and related devices can be reduced, not only cost of installation can be saved, but space occupied by the large multi-rechargeable battery charger can be less.

Hence, according to the requirement mentioned above, the present invention is provided.

### SUMMARY OF THE INVENTION

When the known large multi-rechargeable battery charger is installed, material cost is high and it occupies more space. If it is not fully loaded, the part which doesn't work would be kind of waste. Therefore, it is required to have a large multi-rechargeable battery charger which can be properly used, smaller size and capable of adjusting charging time.

According to an aspect of the present invention, a multi-functioned smart switching charger with time stage control includes: a charging device, connected to an AC power, for transforming alternating current from the AC power into fixed output to charge one rechargeable battery; a plurality of output units, each of the output units connecting with a power switch, for charging a rechargeable battery with the direct current from the charging device via the power switch connected to the charging device; a switch control unit, connected with a plurality of switch control lines, each switch control line electrically connected with a power switch, for triggering the power switch to pass the direct current from the charging device to the output unit connected to the power switch, or not triggering the power switch to block the direct current from the charging device to the output unit connected to the power switch; and a charging control unit, electrically connected with the switch control unit and each output unit via a signal connecting line, for detecting a charging characteristic of the rechargeable battery connected to each output unit, and controlling the switch control unit to change trigger status of each power switch by judging the charging characteristic. The charging device outputs the direct current only to one output unit per charging until the rechargeable battery under charging is fully charged, and the switch control unit only triggers one power switch or doesn't trigger any power switch.

Preferably, the switch control unit is further connected with a plurality of signal control lines, each signal control line is connected with a signal switch installed in the signal connecting line between the switch control unit and a specified output unit, for triggering the signal switch to conduct the signal connecting line, or not triggering signal switch to block the signal connecting line.

Preferably, the power switch is a tri-electrode AC switch.

Preferably, the signal switch is a tri-electrode AC switch.

Preferably, the charging control unit further includes a time controller, for controlling the switch control unit not to trigger all power switches within a specified time.

Preferably, the specified time is a peak time of mains supply.

Preferably, when the charging control unit controls the switch control unit to change the trigger status of each power switch, one non-triggered power switch will be triggered after a switching time when the triggered power switch stops being triggered.

Preferably, the charging control unit further comprises an AC power switch, installed between the AC power and the charging device, connected to the switch control unit via a switch control line, for conducting the AC power and the charging device when it is triggered by the switch control unit, or blocking the AC power and the charging device when it is not triggered by the switch control unit.

Preferably, the AC power is a power generator or an output of the mains supply.

Preferably, the signal connecting line conforms to the RS232 specification or the CAM 2.0 specification.

Preferably, current of the fixed output direct current is at least 10 A. Preferably, the charging characteristic is charging voltage or charging current.

The present invention provides a switching charger which utilizes only a charging device to charge connected rechargeable batteries sequentially. It saves material cost and space used. Meanwhile, charging time can be set up to off-peak hours. Power cost for charging can be saved.

### BRIEF DESCRIPTION OF THE DRAWINGS

FIG. 1 is a block diagram of a prior art of a large multi-rechargeable battery charger.

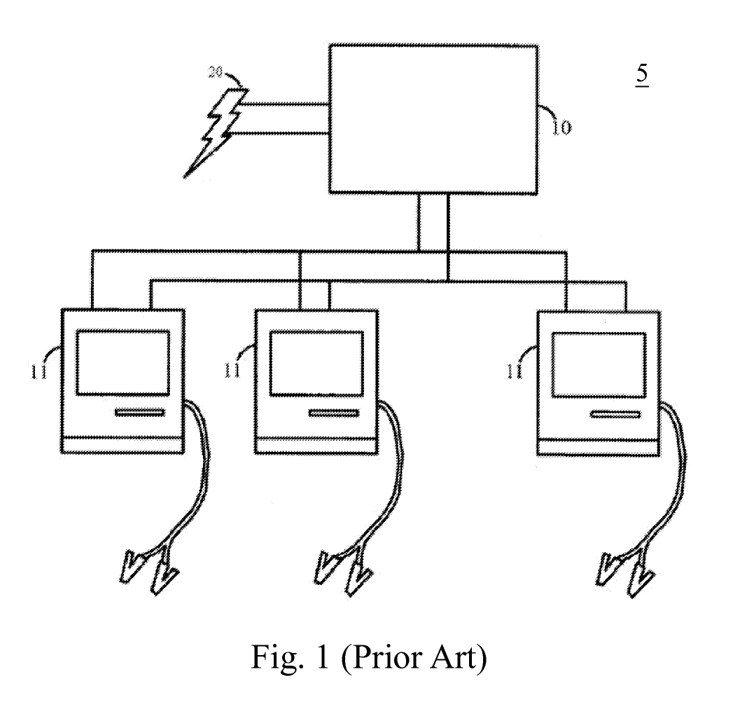

FIG. 2 is a block diagram of a switching charger according to the present invention.

FIG. 3 illustrates triggered time of each power switch in the switching charger.

FIG. 4 illustrates how the switching charger charges a rechargeable battery in a specified time.

### DETAILED DESCRIPTION OF THE PREFERRED EMBODIMENT

The present invention will now be described more specifically with reference to the following embodiment.

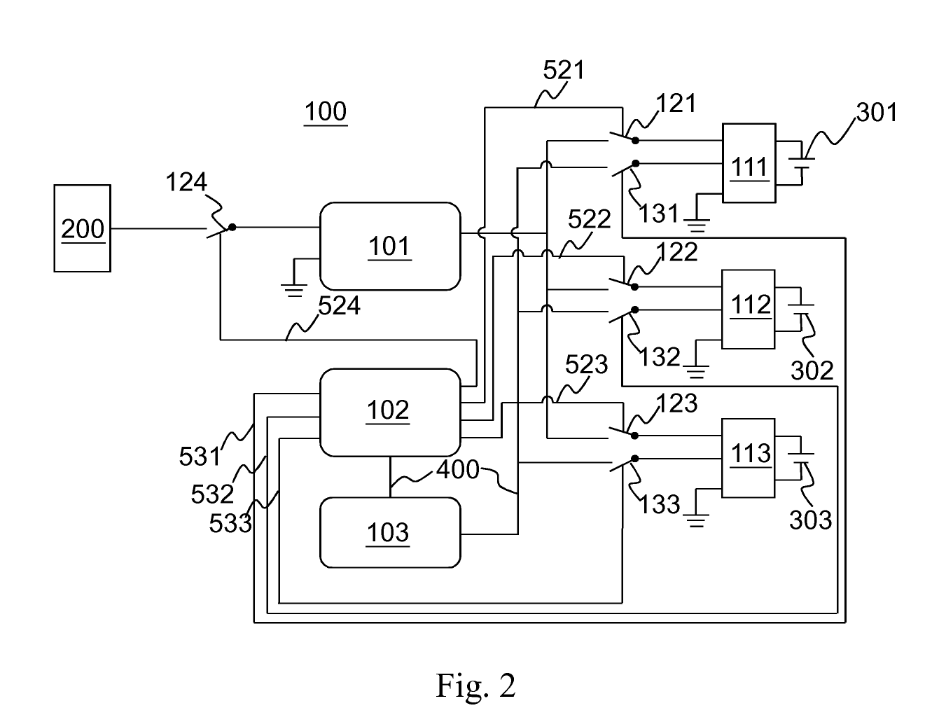

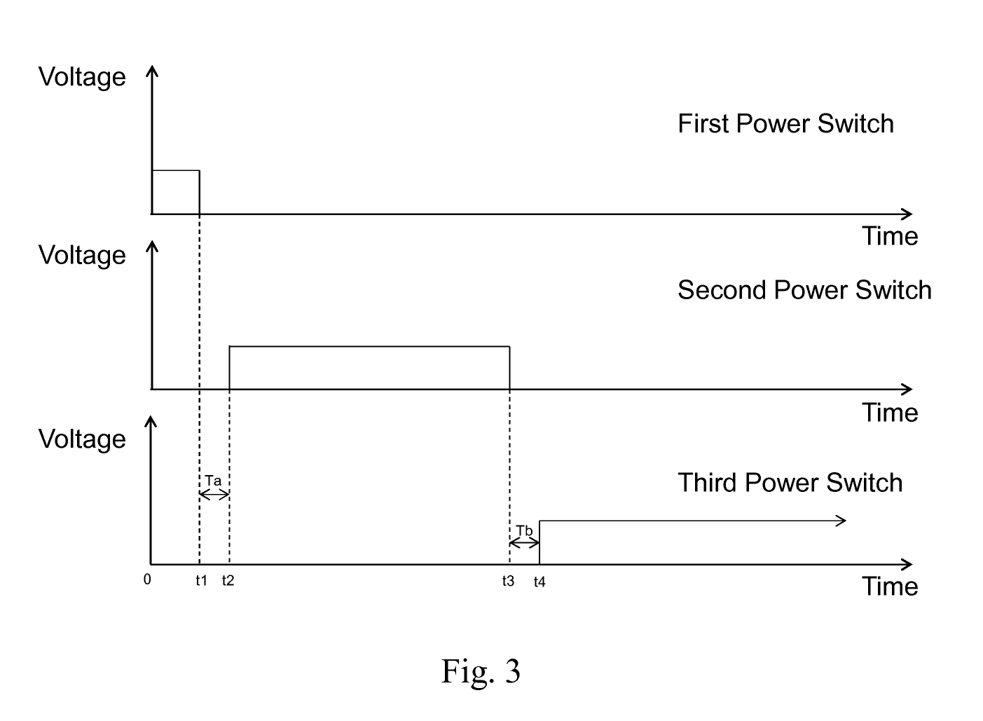

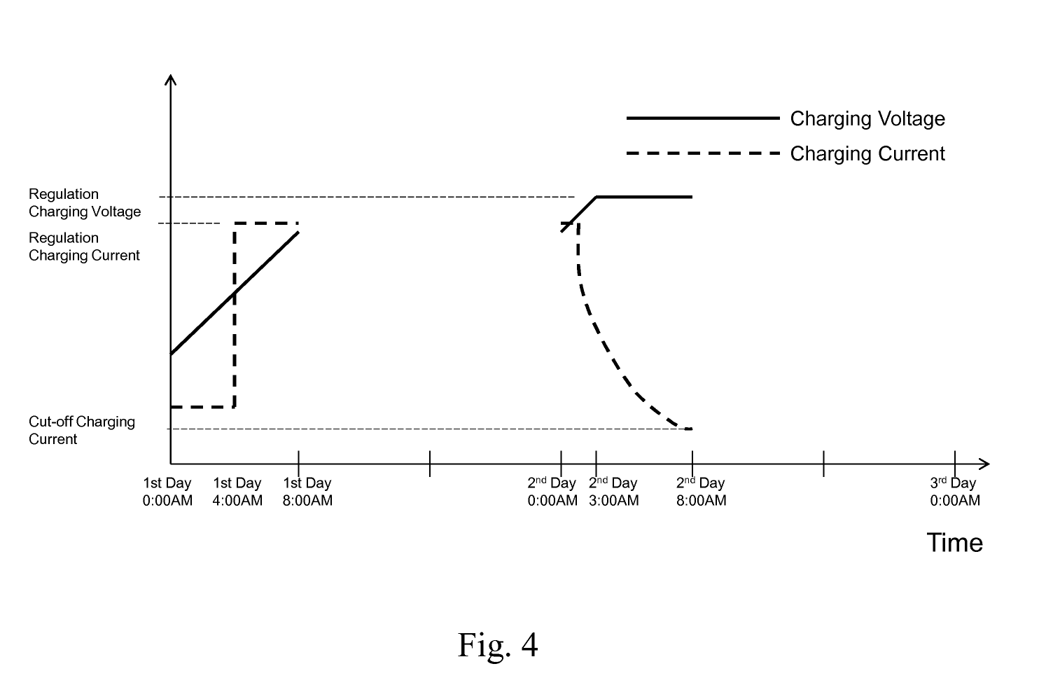

Please refer to FIG. 2 to FIG. 4. FIG. 2 is a block diagram of a switching charger according to the present invention. FIG. 3 illustrates triggered time of each power switch in the switching charger. FIG. 4 illustrates how the switching charger charges a rechargeable battery in a specified time.

A multi-functioned smart switching charger 100 with time stage control according to the present invention includes a charging device 101, three output units (a first output unit 111, a second output unit 112 and a third output unit 113), a switch control unit 102 and a charging control unit 103. The charging device 101 is connected to an AC power 200 via an AC power switch 124. The AC power switch 124 is used to turn on or turn off the line between the charging device 101 and the AC power 200 so as to let the charging device 101 get the alternating current provided by the AC power 200 or not to get it. Details and operation of the AC power switch 124 will be illustrated later. It should be notice that according to the spirit of the present invention, AC power switch 124 can also not to be installed between the charging device 101 and the AC power 200. The AC power switch 124 is used to let the charging device 101 can be reset by rebooting power so that different outputs can be switched to charge different rechargeable batteries. A function of the charging device 101 is to transform alternating current from the AC power into fixed output direct current to charge a rechargeable battery.

In the present embodiment, the AC power 200 is an output of the mains supply (mains supply outlet). In practice, it can also be a power generator. Any equipment or device is able to provide alternating current is the AC power that the present invention claims. In the present embodiment, a preferable fixed output direct current is with 48V and 10 A. Because large electrical machines, such as electrical vehicles, need larger current from the rechargeable batteries to drive comparing with smaller ones, the fixed output direct current for the large electrical machines needs to be at least 10 A in design. Current value falls between 10 A to 20 A is preferable.

Each of the three output units, namely, the first output unit 111, the second output unit 112 and the third output unit 113 is connected to a specified power switch and further connected to the charging device 101 via the power switch. It can charge a rechargeable battery by the direct current from the charging device 101. Please refer to FIG. 2. It is obtained that the first output unit 111 is connected to a first power switch 121 and can charge a first rechargeable battery 301, the second output unit 112 is connected to a second power switch 122 and can charge a second rechargeable battery 302, and the third output unit 113 is connected to a third power switch 123 and can charge a third rechargeable battery 303. Appearances of the rechargeable batteries can be the same or not the same. Charging/discharging capacities of the rechargeable batteries can be identical or not identical. It is only require that the battery management system inside each rechargeable battery can accept the fixed output direct current (having maximum voltage of 48V and current value of 10 A) to charge itself.

Design of the first output unit 111, the second output unit 112 and the third output unit 113 needs to achieve that interface of the output units can match the positions of the corresponding positive and negative electrodes of the rechargeable battery. However, according to the spirit of the present invention, the number of the output units is not limited to three. Since the switching charger 100 is able to charge several rechargeable batteries in different time periods, it is only required that the number of the output units is greater than or equal to two. The first power switch 121, the second power switch 122 or the third power switch 123 is preferable to be a tri-electrode AC switch in practice. Other power switches suitable for controlling larger current can also be used. Category of power switches is not limited.

The switch control unit 102 is connected with four switch control lines. A first switch control line 521 is electrically connected with the first power switch 121, a second switch control line 522 is electrically connected with the second power switch 122, a third switch control line 523 is electrically connected with the third power switch 123 and a fourth switch control line 524 is electrically connected with the AC power switch 124. The first switch control line 521, the second switch control line 522 and the third switch control line 523 can be used to trigger the corresponding power switch, further to pass the direct current from the charging device 101 to the output unit connected to the power switch. The first switch control line 521, the second switch control line 522 and the third switch control line 523 can also not to trigger the corresponding power switch to block the direct current from the charging device 101 to the output unit connected to the power switch. Because the fourth switch control line 524 is electrically connected with the AC power switch 124, the AC power 200 and the charging device 101 can be conducted when the AC power switch 124 is triggered by the switch control unit 102, or the AC power 200 and the charging device 101 are blocked when the AC power switch 124 is not triggered by the switch control unit 102.

The charging control unit 103 is connected to the switch control unit 102, the first output unit 111, the second output unit 112 and the third output unit 113 by a signal connecting line 400. The signal connecting line 400 conforms to RS232 specification. In practice, the signal connecting line 400 can also be designed to conform to CAM 2.0 specification. Hence, although the signal connecting line 400 illustrated in FIG. 2 is not continuous around the charging control unit 103, those who are skilled in RS232 will understand that the signal connecting line 400 is used for data transmission inside electric products. It will not have function differences or discontinuous connection if it passes a number of devices. The charging control unit 103 can detect charging characteristics of the first rechargeable battery 301, the second rechargeable battery 302 and the third rechargeable battery 303 connected to the first output unit 111, the second output unit 112 and the third output unit 113, respectively. Here, the charging characteristic is charging voltage and charging current of each rechargeable battery and can be obtained by the signal connecting line 400 communicating with an internal battery management system in the corresponding rechargeable battery in the first output unit 111, the second output unit 112 and the third output unit 113. The charging control unit 103 can judge if one rechargeable battery is fully charged and another rechargeable battery can proceed to charge, or all connected rechargeable batteries have been charged fully so that the switching charger 100 can stop charging and the switch control unit 102 can be controlled to change trigger status of each power switch according to the charging characteristics. For example, when the charging control unit 103 notices that the charging current of the first rechargeable battery 301 has dropped to a preset cut-off charging current in the voltage regulation phase, charging to the first rechargeable battery 301 can stop. After a period of time, the second rechargeable battery 302 can be charged.

There are some key points of the present invention. The charging device 100 outputs the direct current only to one output unit per charging until the rechargeable battery under charging is fully charged. Only one charging device is used but rechargeable batteries with the same or different specs can be charged in sequence. It saves cost to buy materials of charging devices and reduces space occupied. The switch control unit 102 only triggers one power switch or doesn't trigger any power switch. When the charging control unit 103 controls the switch control unit 102 so as to change the trigger status of each power switch, one non-triggered power switch will be triggered after a switching time when the triggered power switch stops being triggered. In order to have a comprehensive understanding, please refer to FIG. 3. FIG. 3 compares trigger statuses of the first power switch 121, the second power switch 122 and the third power switch 123 in time sequence by combing the results in one figure. A higher voltage represents the power switch is triggered by a triggering voltage. The first power switch 121 is triggered from 0 to t1. The first rechargeable battery 301 is also charged from 0 to t1. The second power switch 122 is triggered from t2 to t3. The second rechargeable battery 302 is also charged from t2 to t3. The third power switch 123 is charged from t4. The third rechargeable battery 303 keeps being charged. A period Ta between t1 and t2 and a period Tb between t3 and t4 are so called switching time. The switching time is to let the charging device 101 have time to be reset by rebooting power so that different outputs can be switched to charge different rechargeable batteries. It can also to let user have time to change charging priority of the rest rechargeable batteries. Ta and Tb can be the same or different in design. Time stage control is therefore achieved.

In addition, the switch control unit 102 is further connected with three signal control lines (a first signal control line 531, a second signal control line 532 and a third signal control line 533). Each signal control line is connected with a signal switch installed in the signal connecting line between the switch control unit 102 and a specified output unit. That is the first signal control line 531 is connected with a first signal switch 131 connected to the first output unit 111, the second signal control line 532 is connected with a second signal switch 132 connected to the second output unit 112 and the third signal control line 533 is connected with a third signal switch 133 connected to the third output unit 113. The switch control unit 102 can trigger those signal switches to conduct the corresponding signal connecting line, or not to trigger the signal switch to block the corresponding signal connecting line. Design of the first signal control line 531, the second signal control line 532, the third signal control line 533, the first signal switch 131, the second signal switch 132 and the third signal switch 133 is to cut off the signal connecting line after one rechargeable battery finishes charging in case the charging control unit 103 receives lots of noises after the rechargeable battery is taken away. In practice, the signal switch can be a tri-electrode AC switch.

In addition, according to the spirit of the present invention, the charging control unit 103 can further to include a time controller (not shown). It can control the switch control unit 102 not to trigger all power switches within a specified time. This design can process charging in off-peak time of the mains supply (it being the specified time). On one hand, power costs less in the off-peak time. On the other hand, the charging device 100 can take a break. Please see FIG. 4 for detailed operation. FIG. 4 illustrates a rechargeable battery charged in different period of a day. The horizontal axis is a time axis, ranging from 0:00 AM of the first day to 0:00 AM of the third day. Because the charging voltage (solid line) and charging current (dashed line) are described in one figure, the vertical axis isn't defined for any physical quantity. Only several specified points of the charging voltage and charging current are indicated.

The off-peak time is set as 0:00 AM to 8:00 AM every day. A lithium rechargeable battery is processed to charge. The rechargeable battery is estimated to spend 16 hours being fully charged. Therefore, two charging periods are required. The rechargeable battery starts charging at 0:00 AM of the first day and is in a pre-charge phase before 4:00 AM of the first day. The charging voltage increases steadily after 0:00 AM of the first day. Currently, the charging current is in a lower status. After 4:00 AM of the first day and before 8:00 AM of the first day, the rechargeable battery comes into a current regulation phase. The charging current increases to a regulation charging current while the charging voltage keeps going up steadily. 8:00 AM of the first to 0:00 AM of the second day is set to be within the specified time. The switch control unit 102 doesn't trigger any power switch to process charging. After 0:00 AM of the second day, before 3:00 AM of the second day, the rechargeable battery is still in the current regulation phase. When time comes into 3:00 AM of the second day, before 8:00 AM of the second day, the rechargeable battery is a voltage regulation phase. The charging voltage keeps at a charging voltage value while the charging current drops. When the charging current drops to a preset cut-off charging current, charging process stops. If the time that rechargeable battery stops charging is over falls in the specified time (8:00 AM to 0:00 AM the next day), charging process will last.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A multi-functioned smart switching charger with time stage control, comprising:
a charging device, connected to an AC power, for transforming alternating current from the AC power into fixed output direct current to charge one rechargeable battery;
a plurality of output units, each of the output units connecting with a power switch, for charging a rechargeable battery with the direct current from the charging device via the power switch connected to the charging device;
a switch control unit, connected with a plurality of switch control lines, each switch control line electrically connected with a power switch, for triggering the power switch to pass the direct current from the charging device to the output unit connected to the power switch, or not triggering the power switch to block the direct current from the charging device to the output unit connected to the power switch; and
a charging control unit, electrically connected with the switch control unit and each output unit via a signal connecting line, for detecting a charging characteristic of the rechargeable battery connected to each output unit, and controlling the switch control unit to change trigger status of each power switch by judging the charging characteristic;
wherein the charging device outputs the direct current only to one output unit per charging until the rechargeable battery under charging is fully charged, and the switch control unit only triggers one power switch or doesn't trigger any power switch.

2. The switching charger according to claim 1, wherein the switch control unit is further connected with a plurality of signal control lines, each signal control line is connected with a signal switch installed in the signal connecting line between the switch control unit and a specified output unit, for triggering the signal switch to conduct the signal connecting line, or not triggering signal switch to block the signal connecting line.

3. The switching charger according to claim 1, wherein the power switch is a tri-electrode AC switch.

4. The switching charger according to claim 2, wherein the signal switch is a tri-electrode AC switch.

5. The switching charger according to claim 1, wherein the charging control unit further comprises a time controller, for controlling the switch control unit not to trigger all power switches within a specified time.

6. The switching charger according to claim 1, wherein the specified time is a peak time of mains supply.

7. The switching charger according to claim 1, wherein when the charging control unit controls the switch control unit to change the trigger status of each power switch, one non-triggered power switch will be triggered after a switching time when the triggered power switch stops being triggered.

8. The switching charger according to claim 1, wherein the charging control unit further comprises an AC power switch, installed between the AC power and the charging device, connected to the switch control unit via a switch control line, for conducting the AC power and the charging device when it is triggered by the switch control unit, or blocking the AC power and the charging device when it is not triggered by the switch control unit.

9. The switching charger according to claim 1, wherein the AC power is a power generator or an output of the mains supply.

10. The switching charger according to claim 1, wherein the signal connecting line conforms to the RS232 specification or the CAM 2.0 specification.

11. The switching charger according to claim 1, wherein current of the fixed output direct current is at least 10 A.

12. The switching charger according to claim 1, wherein the charging characteristic is charging voltage or charging current.
